(19) United States
(12) Patent Application Publication
(10) Pub. No.: US 2016/0183297 A1
(43) Pub. Date: Jun. 23, 2016

(54) Wireless Communications System and Transmission Method Thereof

(71) Applicant: MEDIATEK INC., Hsin-chu (TW)

(72) Inventors: Chia-Hsiang Hsu, Kaohsiung City (TW); Shih-Chang Su, Hsinchu County (TW); Hao-Hua Kang, Taoyuan City (TW)

(21) Appl. No.: 14/964,580

(22) Filed: Dec. 10, 2015

Related U.S. Application Data
(60) Provisional application No. 62/094,082, filed on Dec. 19, 2014.

(51) Int. Cl. H04W 74/04; H04L 5/22

(52) U.S. Cl. CPC H04W 74/04; H04L 5/22

(57) ABSTRACT

A transmission method for a wireless communications system having a first communications device and a second communications includes when the first communications device receives an external clear to send signal, the first communications device is disabled so as to stop the first communications device from sending a first radio signals during a first time interval. The second communications device sends the clear to send signal right after the first time interval so as to stop the first communications device from sending the first radio signals during a second time interval. The first communications device is enabled to send the first radio signals right after the second time interval.

### CROSS REFERENCE TO RELATED APPLICATIONS

This application claims the benefit of U.S. provisional application No. 62/094,082, filed Dec. 19, 2014.

### BACKGROUND

Wireless communication has been an important and essential data transmission technique in recent years since it takes several advantages such as high transmission flexibility, high transmission convenience, and high transmission quality. Nowadays, several wireless communications modules for sending various radio signals are integrated into a portable electronic device. For example, a Bluetooth (BT) module, a Wi-Fi module, and a long-term-evolution (LTE) module are integrated in a smartphone. To improve the transmission efficiency, two transmission types are applied to achieve the coexistence of multi-radios transmission. The first transmission type is frequency division duplex (FDD). The second transmission type is time division duplex (TDD). The key idea of the transmission using FDD is to partition a wireless frequency spectrum into several frequency bands and further allocate each radio signal to the corresponding frequency band. The key idea of the transmission using TDD is to determine several time slots during a transmission time interval and then allocate each radio signal to the corresponding time slot. Both FDD and TDD can provide multi-radios coexistence transmission.

However, in FDD transmission, the transmission performance may be sacrificed since the filter used in FDD circuit reduces the signal dynamic range of transmission. Further, FDD circuit requires larger layout size than TDD circuit. Thus, TDD takes more attention for applying to a small and precision electronic device.

In TDD transmission, since each radio signal is allocated to different time slot, only one radio signal is activated at a time instant. When two radio signals are accessed in the same time (i.e., two radio signals are allocated to the same slot) by external command, error, or time slot shifting, the inter-radio interference is introduced, leading to performance degradation and information loss of the transmission. Thus, to develop a TDD transmission method which can minimize the inter-radio interference is an important issue.

### SUMMARY

In an embodiment of the present invention, a transmission method for a wireless communications system is disclosed. The wireless communications system includes a first communications device and a second communications device. The method includes when the first communications device receives an external clear to send signal (CTS), the first communications device is disabled so as to stop the first communications device from sending a first radio during a first time interval. The second communications device broadcasts the clear to send signal right after the first time interval so as to stop the first communications device from sending the first radio during a second time interval. The first communications device is enabled to send the first radio right after the second time interval.

In another embodiment of the present invention, a wireless communications system includes a first communications device configured to send a first radio, and a second communications device, wherein the first communications device is disabled so as to stop the first communications device from sending the first radio during a first time interval when the first communications device receives an external clear to send signal (CTS). The second communications device sends/broadcasts the clear to send signal right after the first time interval so as to stop the first communications device from sending the first radio during a second time interval. The first communications device is enabled to send the first radio right after the second time interval.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic structure of wireless communications system according to an embodiment of the present invention.

FIG. 2 shows a transmission method for a wireless communications system according to the first embodiment of the present invention.

FIG. 3 shows a transmission method for a wireless communications system according to the second embodiment of the present invention.

### DETAILED DESCRIPTION

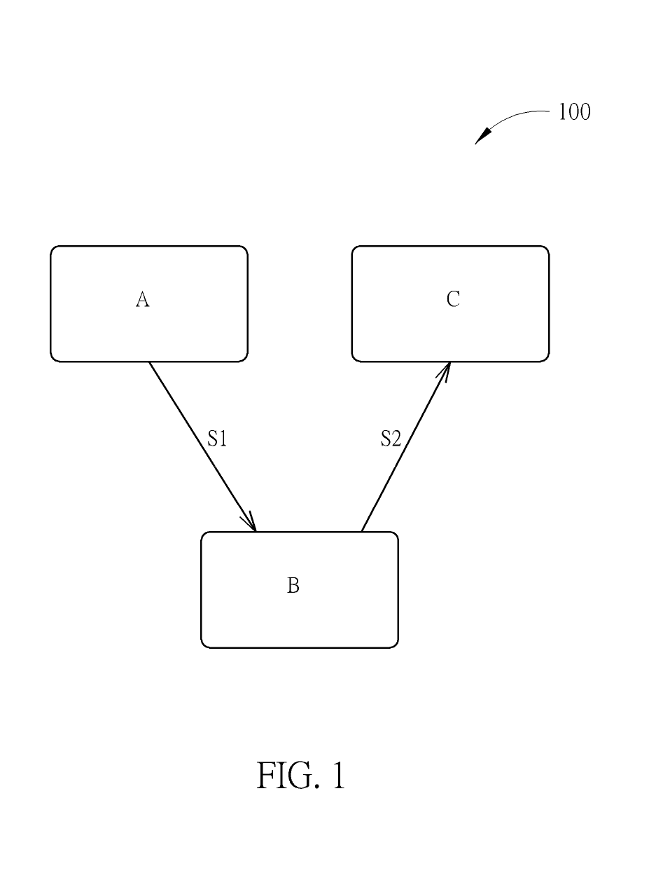

FIG. 1 is a schematic structure of wireless communications according to an embodiment of the present invention. As shown in FIG. 1, the wireless communications system that may be a time division duplex system 100 includes a communications device A, a communications device B, and a communications device C. Radio signals S1 and radio signals S2 are considered in this embodiment. Specifically, radio signals S1 and radio signals S2 can be heterogeneous radio signals. For example, radio signals S1 can be 802.11 (Wi-Fi) signals and radio signals S2 can be Bluetooth signals. However radio signals S1 and radio signals S2 can also be homogeneous radio signals. For example, both radio signals S1 and radio signals S2 can be 802.11 (Wi-Fi) signals or Bluetooth signals. The communications device A can communicate with the communications device B through radio signals S1. While the communications device B can also communicate with the communications device C through radio signals S2. In time division duplex transmission, only one of the radio signals S1 and S2 is accessed in communications device B (i.e., transmitting/receiving radio signals S1 or sending radio signals S2). To avoid inter-radio interference, the communications device B broadcasts a clear to send (CTS) signal before the communications device B sends the radio signals S2. Here, when the CTS signal is received by the communications device A, the transmission of the radio signals S1 in the communications device A is disabled during a time interval included in the CTS signal. Thus, the communications device B can send radio signals S2 during a time interval without any inter-radio interference caused by radio signals S1.

In the embodiment, the time division duplex system 100 is considered to receive an external CTS (ECTS) signal broadcasted by another communications device (i.e., for example, another smartphone) to avoid inter-radio interference. When the communications device A and communications device B receive the ECTS signal, the radio signals S1 between the communications device A and the communications device B is disabled and the transmission of the CTS signal in the communications device B is also disabled during a time interval. Since the transmission of the CTS signal from the communications device B is disabled, the inter-radio interference may be introduced when the communications device B sends the radio signals S2.

In the present invention, when the ECTS signal is received, to ensure no inter-radio interference being introduced in time division duplex system 100, the communications device B has to broadcast an additional CTS signal to prevent from inter-radio interference. The detail transmission method is illustrated below.

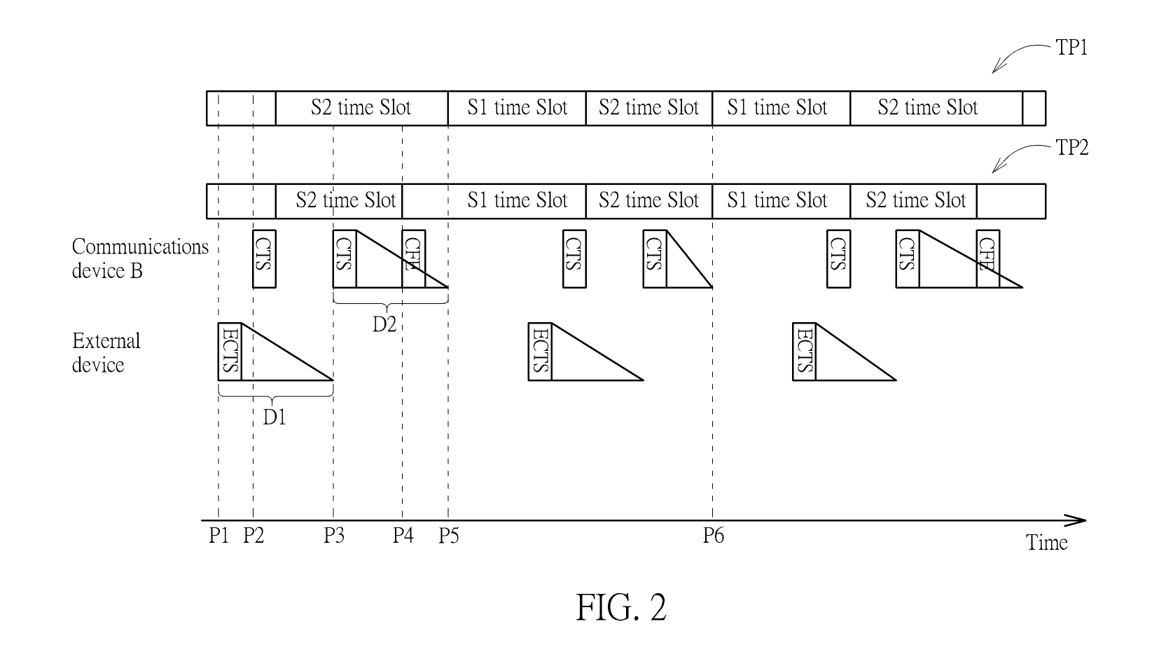

FIG. 2 shows a transmission method for a wireless communications system that may be a time division duplex system according to the first embodiment of the present invention. As shown in FIG. 2, a radio activity schedule TP1 for the communications device B is illustrated and the information of the radio activity schedule TP1 can be stored in the communications device B. The radio activity schedule TP1 includes several time slots allocated to radio signals S1 and radio signals S2. By default, the schedule for transmitting/receiving radio signals S2 and sending radio signals S1 is illustrated in the radio activity schedule TP1. In FIG. 2, the length of each time slot of radio signals S1 denotes the length of each period for receiving radio signals S1. The length of each time slot of radio signals S2 denotes the length of each period for sending radio signals S2. The length of each period for receiving radio signals S1 and a length of each period for sending radio signals S2 can be fixed or variable. A real-time radio activity schedule TP2 is similar to the radio activity schedule TP1, which denotes the schedule of the radio signals in real-time transmission. Since the wireless channel gain is time-variant, the transmission performance and capability of the radio signals in real-time channel environment vary. As a result, each time slot in real-time radio activity schedule TP2 may have a time-offset (i.e., time slot shifting) compared with the radio activity schedule TP1. For example, the length of the first time slot of radio signals S2 in the radio activity schedule TP1 is determined as 10 ms by default. If no severe channel fading is suffered when the communications device B sends radio signals S2, radio signals S2 only need 8 ms for transmission. Thus, the length of the first time slot of radio signals S2 in the real-time radio activity schedule TP2 is shorter than the length of the first time slot of radio signals S2 in the radio activity schedule TP1.

In FIG. 2, when the time division duplex system 100 receives an external CTS (ECTS) signal from an external device (i.e., the ECTS can be broadcasted from another communication device to prevent from the inter-radio interference) at time P1, the communications device A is disabled during a time interval D1 so that the sending of radio signals S1 from the communications device A is terminated during the time interval D1. The broadcasting of CTS signal at time P2 from the communications device B is also disabled. The end of the time interval D1 of the ECTS signal is at time P3. In this embodiment, after time P3, the communications device B broadcasts the CTS signal. When the communications device A receives the CTS signal from the communications device B, the communications device A is disabled during a time interval D2 so that the sending of the radio signals S1 from the communications device A is still terminated during the time interval D2. Here, the end of the time interval D2 with respect to the CTS signal is equal to the end of the first time slot of the radio S2 according to the radio activity schedule TP1 (i.e., time P5). Since the communications device A receives the CTS signal followed by the ECTS signal, the sending of radio signals S1 from the communications device A is terminated during the consecutive time interval D1 and time interval D2 (i.e., time P1 to time P5). Since the first time slot of radio signals S2 is allocated within the time range from time P1 to time P5, no inter-radio interference is introduced when the communications device B sends radio signals S2. After time P5, the communications device A is enabled to send radio signals S1. Since the transmission method in the subsequent time slots of radio S1 signals and time slots of radio signals S2 is similar and periodic, the illustrations of the similar transmission method in the subsequent time slots are omitted.

In this embodiment, a contention free end (CFE) signal is further introduced to improve the transmission efficiency. The function of CFE is described below. In FIG. 2, after time P3, the CTS signal is sent from the communications device B to avoid inter-radio interference during the time interval D2. The end of the time interval D2 of the CTS signal is the end of the first time slot of radio signals S2 according to the radio activity schedule TP1 (i.e., time P5). Thus, if no severe channel fading is suffered when the communications device B sends the radio signals S2, only a few re-transmissions are required (i.e., for example, hybrid automatic repeat request transmission). As a result, the real transmission length of radio signals S2 is shorter than the predetermined transmission time length of radio signals S2. For example, the length of the first time slot of radio S2 in the real-time radio activity schedule TP2 is shorter than the length of the first time slot of radio signals S2 in the radio activity schedule TP1. When the communications device B completely sends the information of the first time slot of radio signals S2 at time P4, the communications device B broadcasts the CFE signal. When the communications device A receives the CFE signal, the communications device A is enabled to send radio signals S1. Since the communications device B completes sending radio signals S2 at time P4, no inter-radio interference is introduced when the communications device B receives radio signals S1 sent from the communications device A after time P4. Since the communications device A can be adaptively enabled to send radio signals S1 according to the CFE signal, the transmission efficiency can be improved. In this embodiment, when the ends of the time slot of the radio signals S2 in the radio activity schedule TP1 and the real-time radio activity schedule TP2 are at the same time point (i.e., for example, the time P6), no CFE signal is required to enable the communications device A for sending radio signals S1 ahead of schedule.

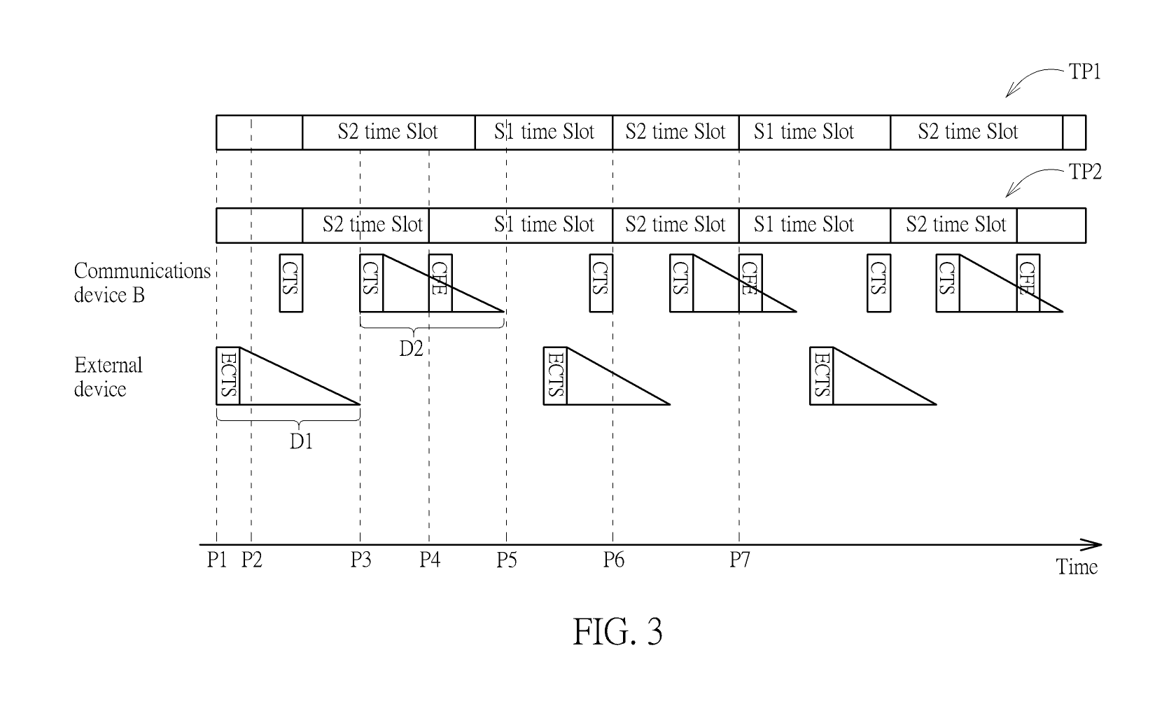

FIG. 3 is a transmission method for a time division duplex system according to the second embodiment of the present invention. In FIG. 3, the radio activity schedule TP1, the real-time radio activity schedule TP2, the CTS signal, the ECTS signal, the CFE signal, and the transmission method are similar to the first embodiment in FIG. 2. As shown in FIG. 3, the length of the first time slot of radio signals S2 in the real-time radio activity schedule TP2 is shorter than the length of the first time slot of radio signals S2 in the radio activity schedule TP1. According to an embodiment of the present invention, the length of the CTS time interval D2 is determined according to a predetermined time interval of another communications device. Hence, the length the CTS time interval D2 can equal to the length of the first S2 time slot in TP1 shown in FIG. 3. Further, according to another embodiment of the present invention, the length of the next CTS can equal to the length of the second S2 time slot in TP1. Yet according to another embodiment of the present invention, the length of the third CTS can equal to the length of the third S2 time slot in TP1. When the communications device B completely sends the information in the first time slot of radio signals S2 at time P4, the communications device B broadcasts the CFE signal. In FIG. 3, after time P6, the length of the second time slot of radio signals S2 in the real-time radio activity schedule TP2 is equal to the length of the second time slot of radio signals S2 in the radio activity schedule TP1. The end of the second time slot of radio signals S2 in the real-time radio activity schedule TP2 is at the same time as the end of the second time slot of radio signals S2 in the radio activity schedule TP1 (i.e., the time P7). Different from the first embodiment, the end of the time interval D2 of the CTS signal is not at time P7 since the end of the time interval D2 satisfies that the length of the time interval D2 is equal to the length of the time interval D1. Here, the CFE signal is required to enable the communications device A for sending radio signals S1 in order to improve the transmission efficiency.

Generally, in the first embodiment of the present invention, the transmission method for time division duplex system 100 uses CFE signals after the communications device B sends radio signals S2 in order to improve the transmission efficiency when the length of the time slot for sending radio signals S2 in the real-time radioactivity schedule TP2 is shorter than the length of the time slot for sending radio signals S2 in the radio activity schedule TP1. In the second embodiment of the present invention, the transmission method for time division duplex system 100 may use the CFE signals after the communications device B sends radio signals S2 in order to improve the transmission efficiency since the length of time interval D2 corresponding to CTS signal is equal to the length of time interval D1 corresponding to ECTS signal. However, in another embodiment, if the time division duplex system 100 cannot access the medium or the remaining time reserved by the CTS is not long enough, the time division duplex system 100 may not send the CFE.

In the present invention, a wireless communications system and a transmission method for the wireless communications system are disclosed. The key idea of the transmission method is to use the additional CTS signal to protect the current transmission of radio signals. To avoid inter-radio interference, the additional CTS signal is broadcasted right after the time interval of the ECTS signal so as to stop other communications devices from sending other radio signals. Additionally, to improve the transmission efficiency, the transmission method uses a CFE signal to adaptively control (enable) other communications devices to send the radio signals when the transmission of the current radio signals is completed ahead of schedule.

Those skilled in the art will readily observe that numerous modifications and alterations of the device and method may be made while retaining the teachings of the invention. Accordingly, the above disclosure should be construed as limited only by the metes and bounds of the appended claims.

What is claimed is :

1. A transmission method for a wireless communications system, the wireless communications system comprising a first communications device and a second communications device, the method comprising:
when the first communications device receives an external clear to send signal (ECTS) , disabling the first communications device so as to stop the first communications device from sending a first radio signal during a first time interval;
the second communications device sending a clear to send signal right after the first time interval so as to stop the first communications device from sending the first radio signals during a second time interval; and
the first communications device sending the first radio signals right after the second time interval.

2. The method of claim 1, wherein an end of the second time interval is an end of a period for sending the second radio signals according to a radio activity schedule.

3. The method of claim 1, wherein the second time interval is determined according to a predetermined time interval of another communications device.

4. The method of claim 2, wherein the first radio signals and the second radio signals are homogeneous radio signals.

5. The method of claim 2, wherein the first radio signals and the second radio signals are heterogeneous radio signals.

6. The method of claim 2, wherein a length of each period for receiving the first radio signals and a length of each period for sending the second radio signals are variable.

7. The method of claim 2, wherein a length of each period for receiving the first radio signals and a length of each period for sending the second radio signals are fixed.

8. The method of claim 2, wherein one of a length of each period for receiving the first radio signals and a length of each period for sending the second radio signals is variable, and another one of the length of each period for receiving the first radio signals and the length of each period for sending the second radio signals is fixed.

9. A wireless communications system comprising:
a first communications device configured to send a first radio signals; and
a second communications device;
wherein the first communications device is disabled from sending the first radio signals during a first time interval when the first communications device receives an external clear to send signal (ECTS), the second communications device sends a clear to send signal right after the first time interval so as to stop the first communications device from sending the first radio signals during a second time interval, and the first communications device is enabled to send the first radio signals right after the second time interval.

10. The system of claim 9, wherein the second communications device comprises:
a radio activity schedule, comprising periods for receiving the first radio signals and periods for sending a second radio signals.

11. The system of claim 10, wherein an end of the second time interval is an end of a period for sending the second radio signals according to the radio activity schedule.

12. The system of claim 9, wherein the second time interval is determined according to a predetermined time interval of another communications device.

13. The system of claim 10, wherein the first radio signals and the second radio signals are homogeneous radio signals.

14. The system of claim 10, wherein the first radio signals and the second radio signals are heterogeneous radio signals.

15. The system of claim 10, wherein a length of each period for receiving the first radio signals and a length of each period for sending the second radio signals are variable.

16. The system of claim 10, wherein a length of each period for receiving the first radio signals and a length of each period for sending the second radio signals are fixed.

17. The system of claim 10, wherein one of a length of each period for receiving the first radio signals and a length of each period for sending the second radio signals is variable, and another one of the length of each period for receiving the first radio signals and the length of each period for sending the second radio signals is fixed.
